(19) United States
(12) Patent Application Publication
(10) Pub. No.: US 2006/0063691 A1
(43) Pub. Date: Mar. 23, 2006

(54) Water-soluble, liquid-containing pouch

(75) Inventors: Massimiliano Carlomagno, Brussel (BE); James Pyott Johnston, Merchtem (BE); Anthony James Steventon, Surrey (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/221,503

(22) Filed: Sep. 8, 2005

(30) Foreign Application Priority Data
Sep. 17, 2004 (EP) 04077579.3

(51) Int. Cl. C11D 17/00

(52) U.S. Cl. 510/295; 510/438; 510/296

(57) ABSTRACT

The present invention relates to a water-soluble liquid-containing pouch wherein the water-soluble pouch is made from a film comprising a co-polymer of dicarboxylic acid, preferably itaconic acid, and wherein the liquid contained within the pouch comprises dissolved ionic components selected from the group consisting of carboxylates, phosphonates, and mixtures thereof.

The present invention relates to water-soluble liquid-containing pouch, especially to pouches containing cleaning liquids such as detergents and hard surface cleaners.

### BACKGROUND OF THE INVENTION

Liquid-filled pouches are known as a convenient form of packaging consumer products as well as agrochemical and industrial products. The liquid can be provided in pre-measured quantities intended for use as “unit doses”. The film enveloping the liquid product, which forms the wall of the pouch, may optionally be soluble in water. A particularly suitable water-soluble film for this purpose is made from polyvinyl alcohol, and, in this context, this invention is particularly suited to packaging unit doses of liquid detergent.

Alkaline products in liquid have been packaged in water-soluble films wherein the film is made from a water-soluble polymer comprising carboxylic acid groups. However most water-soluble films, when used in combination with liquids may form lactones. This problem is particularly apparent when the liquid has a near-neutral pH. Lactone formation is undesirable it results in films which are poorly soluble in water and which leave unsightly polymer residues.

U.S. Pat. No. 3,689,469, issued on Sep. 5^{th} 1972, discloses co-polymers of vinyl alcohol and methyl methacrylate (a monocarboxylic acid) which inhibits the close packing of the molecules and minimizes the tendency of polyvinyl alcohol to form crystallites. The more closely packed, the more difficult it is to dissolve polyvinyl alcohol in water.

U.S. Pat. No. 4,885,105, issued on Dec. 5^{th} 1989, reports that the presence of adjacent alcohol and carboxylic esters causes the formation of internal lactone rings. Conversion of the lactone to anionic form (by treating with a base) may occur as part of the resin or film production process, or after the film has been made but before it is intended to dissolve in water. The introduction of a cleaning composition to the film will result in a degree of anion formation if the cleaning composition is sufficiently alkaline. In this patent the alkaline cleaning compositions are generally defined as those which generate a pH of greater than about 8 when dissolved to a level of about 1% in an aqueous medium.

The present invention addresses the problem of water-solubility, and avoidance of polymer residues, of a water-soluble liquid-containing pouch wherein the liquid contained within the pouch comprises dissolved ionic components.

### SUMMARY OF THE INVENTION

The present invention provides a water-soluble pouch made from a film comprising a co-polymer of dicarboxylic acid wherein the liquid contained within the pouch comprises dissolved ionic components selected from the group consisting of phosphonates, carboxylates, and mixtures thereof.

### DETAILED DESCRIPTION OF THE INVENTION

A preferred water-soluble film comprises from polymers, copolymers or derivatives thereof selected from polyvinyl alcohols, polyalkylene oxides, acrylic acid, cellulose, cellulose ethers, cellulose esters, polyvinyl acetates, polycarboxylic acids and salts, polyaminoacids or peptides, polyamides, copolymers of maleic/acrylic acids, polysaccharides including starch and gelatine, natural gums such as xanthum and carragum. More preferably the polymer is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, most preferably polyvinyl alcohols, polyvinyl alcohol copolymers and hydroxypropyl methyl cellulose (HPMC). Preferably, the level of a type polymer (e.g., commercial mixture) in the film material, for example PVA polymer, is at least 60% by weight of the film. The polymer can have any weight average molecular weight, preferably from about 1000 to 1,000,000, or more preferably from 10,000 to 300,000, or even more preferably from 15,000 to 200,000, or most preferably from 20,000 to 150,000. Mixtures or blends of polymers may be used.

Highly preferred is polyvinyl alcohol formed by extrusion, blow-extrusion, blow-molding, extrusion casting or solution casting into a thin film. Such a film is preferably 10 to 200 micrometers thick, more preferably from 40 to 100 micrometers thick.

Most preferred material for making the water-soluble pouch comprises water-soluble polyvinyl alcohol (including co-polymers thereof), preferably wherein the polymer present in the film is from 60 to 100% hydrolysed, more preferably 80% to 98% hydrolysed, to improve the dissolution of the material.

The water-soluble film herein may comprise other additive ingredients than the polymer or polymer material. For example, it may be beneficial to add plasticisers, for example glycerol, ethylene glycol, diethyleneglycol, propylene glycol, propane diol, sorbitol and mixtures thereof, additional water, disintegrating aids, fillers, anti-foaming agents, emulsifying/dispersing agents, and/or antiblocking agents. It may be useful that the pouch or water-soluble film itself comprises a detergent additive to be delivered to the wash water, for example organic polymeric soil release agents, dispersants, dye transfer inhibitors. Optionally the surface of the film of the pouch may be dusted with fine powder to reduce the coefficient of friction. Sodium aluminosilicate, silica, talc and amylose are examples of suitable fine powders.

According to the present invention the water-soluble film is made from a co-polymer which further comprises dicarboxylic acid. Preferably the co-polymer comprises vinyl alcohol and dicarboxylic acid, and it is most preferred that the co-polymer comprises from 0.1 mol % to 30 mol %, especially from 1 mol % to 6 mol %, of the dicarboxylic acid.

Suitable dicarboxylic acids are itaconic acid, maleic acid, malonic acid, succinic acid and mixtures thereof. Most preferred is itaconic acid.

It has been found that films made from co-polymer comprises vinyl alcohol and dicarboxylic acid have much better dissolution and disintegration profiles even when the liquid contains cleaning performance enhancing carboxylates and phosphonates, and even when the liquid is formulated at pH less than 9. The improvement in dissolution and disintegration profiles is particularly noticeable after several weeks storage of the liquid-containing pouches.

The term “liquid” is used herein to broadly include, for example, mixtures, solutions, dispersions and emulsions, although homogeneous solutions are most preferred. The liquid may be from low to very high viscosities including gels and pastes. The preferred viscosity may be up to 10,000 mPa·s, but it is more preferably from 100 to 1000 mPa·s, and most preferably from 300 to 500 mPa·s. The liquid may contain active ingredients suitable for various applications. Examples of such applications are agrochemicals, e.g. pesticides, herbicides, fungicides, insecticides; industrial chemicals, e.g. materials used in construction industries, materials used in photography, printing and textile industries; chemicals for treating water, e.g. swimming pools, water heating systems, sewage and drainage systems; health and beauty care products, e.g. pharmaceutical and cosmetic applications; domestic and consumer products, e.g. laundry cleaning and treatment, dish and hard surface cleaning, shampoo, bath additives. Particularly preferred liquids are suitable for use as liquid detergents in the cleaning of clothes, dishes, and other household surfaces.

It is preferred that the liquid compositions of the present invention are homogeneous solutions and, in particular, that the carboxylate and phosphonate components are dissolved in the homogeneous liquid.

The liquid composition preferably has a density of 0.8 kg/l to 1.3 kg/I, preferably about 1.0 to 1.1 kg/I. The liquid composition can made by any method and can have any viscosity, typically depending on its ingredients. The viscosity may be controlled, if desired, by using various viscosity modifiers such as hydrogenated castor oil and/or solvents. Hydrogenated castor oil is commercially available as Thixcin®. Suitable solvents are described in more detail below.

The liquid compositions of the present invention are concentrated and contain relatively low levels of water. The liquid compositions comprise less than 25% by weight water, and preferably between 5-15% by weight water. However, suitable compositions may even comprise less than 5% by weight water.

The liquid of the present invention preferably has a pH of less than 9, preferably less than 8, more preferably less than 7.5, when measured by dissolving the liquid to a level of 1% in an aqueous medium.

The liquid compositions of the present invention comprise components selected from the group consisting of carboxylates, phosphonates and mixtures thereof. These components are effective builder/chelant actives used for binding metal ions in aqueous solutions. The term carboxylates as used herein encompasses the acid form of the salt and also encompasses “polycarboxylate” which refers to compounds having a plurality of carboxylate groups, preferably at least three carboxylates. Polycarboxylate builder can generally be added to the composition in acid form, but can also be added in the form of a neutralized salt. When utilized in salt form, alkali metals, such as sodium, potassium, and lithium, or alkanolammonium salts are preferred.

Included among the polycarboxylate builders are a variety of categories of useful materials. One important category of polycarboxylate builders encompasses the ether polycarboxylates, including oxydisuccinate, as disclosed in Berg, U.S. Pat. No. 3,128,287, issued Apr. 7, 1964, and Lamberti et al, U.S. Pat. No. 3,635,830, issued Jan. 18, 1972. See also “TMS/TDS” builders of U.S. Pat. No. 4,663,071, issued to Bush et al, on May 5, 1987. Suitable ether polycarboxylates also include cyclic compounds, particularly alicyclic compounds, such as those described in U.S. Pat. Nos. 3,923,679; 3,835,163; 4,158,635; 4,120,874 and 4,102,903.

Other useful detergency builders include the ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxy-disuccinic acid, polymaleic acid, benzene 1,3,5-tricarboxylic acid, carboxymethyloxysuccinic acid, and soluble salts thereof.

Citrate builders, e.g., citric acid and soluble salts thereof (particularly sodium salt), are polycarboxylate builders of particular importance for heavy duty liquid detergent formulations due to their availability from renewable resources and their biodegradability. Oxydisuccinates are also especially useful in such compositions and combinations.

Also suitable in the liquid detergent compositions of the present invention are the 3,3-dicarboxy-4-oxa-1,6-hexanedioates and the related compounds disclosed in U.S. Pat. No. 4,566,984, Bush, issued Jan. 28, 1986. Useful succinic acid builders include the C₅-C₂₀ alkyl and alkenyl succinic acids and salts thereof. A particularly preferred compound of this type is do-decenylsuccinic acid. Specific examples of succinate builders include: laurylsuccinate, myristylsuccinate, palmitylsuccinate, 2-dodecenylsuccinate (preferred), 2-pentadecenylsuccinate, and the like. Laurylsuccinates are the preferred builders of this group, and are described in EP-A-0 200 263, published Nov. 5, 1986.

Specific examples of nitrogen-containing, phosphor-free aminocarboxylates include ethylene diamine disuccinic acid and salts thereof (ethylene diamine disuccinates, EDDS), ethylene diamine tetraacetic acid and salts thereof (ethylene diamine tetraacetates, EDTA), and diethylene triamine penta acetic acid and salts thereof (diethylene triamine penta acetates, DTPA).

Other suitable polycarboxylates are disclosed in U.S. Pat. No. 4,144,226, Crutchfield et al, issued Mar. 13, 1979 and in U.S. Pat. No. 3,308,067, Diehl, issued Mar. 7, 1967. See also Diehl U.S. Pat. No. 3,723,322. Such materials include the water-soluble salts of homo-and copolymers of aliphatic carboxylic acids such as maleic acid, itaconic acid, mesaconic acid, fumaric acid, aconitic acid, citraconic acid and methylenemalonic acid.

The term phosphonate as used herein encompasses the acid form of the salt. Examples of highly suitable organic phosphonates for use herein are amino alkylene poly (alkylene phosphonates), alkali metal ethane 1-hydroxy bisphosphonates and nitrilo trimethylene phosphonates. Preferred among the above species are diethylene triamine penta (methylene phosphonate), ethylene diamine tri (methylene phosphonate) hexamethylene diamine tetra (methylene phosphonate) and hydroxy-ethylene 1,1 diphosphonate.

Preferred Ingredients of the Liquid Composition

The preferred amounts of ingredients described herein are % by weight of the composition herein as a whole.

If the liquid composition is a detergent composition, it is preferred that at least a surfactant and builder are present, preferably at least anionic surfactant and preferably also nonionic surfactant, and preferably at least a builder, more preferably at least a water-soluble builder such as phosphate builder and/or fatty acid builder. Other preferred components are enzymes and/or bleaching agents, such as a preformed peroxyacid.

Highly preferred are also perfume, brightener, buffering agents (to maintain the pH preferably from 5.5 to 9, more preferably 6 to 8, most preferably about 7.5), fabric softening agents, including clays and silicones benefit agents, suds suppressors.

In hard-surface cleaning compositions and dish wash compositions, it is preferred that at least a water-soluble builder is present, such as a phosphate, and preferably also surfactant, perfume, enzymes, bleach.

In fabric enhancing compositions, preferably at least a perfume and a fabric benefit agent are present for example a cationic softening agent, or clay softening agent, anti-wrinkling agent, fabric substantive dye.

Highly preferred in all above compositions are also additional solvents, such as alcohols, diols, monoamine derivatives, glycerol, glycols, polyalkylane glycols, such as polyethylene glycol, propane diol, monoethanolamine. Highly preferred are mixtures of solvents, such as mixtures of alcohols, mixtures of diols and alcohols, mixtures. Highly preferred may be that (at least) an alcohol, diol, monoamine derivative and preferably even glycerol are present. The compositions of the invention are preferably concentrated liquids having preferably less than 50% or even less than 40% by weight of solvent (other than water), preferably less than 30% or even less than 20% or even less than 35% by weight. Preferably the solvent is present at a level of at least 5% or even at least 10% or even at least 15% by weight of the composition.

Highly preferred is that the composition comprises a plasticiser for the water-soluble pouch material, for example one of the plasticisers described above, for example glycerol. Such plasticisers can have the dual purpose of being a solvent for the other ingredients of the composition and a plasticiser for the pouch material.

### EXAMPLES

| | Compo- | Compo- | Compo- | Comparative |
|---|---|---|---|---|
| | sition 1 | sition 2 | sition 3 | Composition |
| | % Wt. | % Wt. | % Wt. | % Wt. |
| Dodecylbenzene | 21.8 | 20.5 | 19.4 | 23.0 |
| sulphonic acid | | | | |
| C13-C15 | 18.5 | 17.4 | 16.4 | 19.5 |
| alcohol, | | | | |
| ethoxylated | | | | |
| 7 times | | | | |
| C8-C10 alkyl | 1.7 | 1.6 | 1.5 | 1.8 |
| amidopropyl- | | | | |
| methyl amine | | | | |
| C12-C18 alkyl | 16.4 | 15.4 | 14.6 | 17.3 |
| fatty acid | | | | |
| Citric acid | 1.5 | 1.4 | 1.3 | 0 |
| Diethylene | 0.9 | 0.9 | 0.8 | 0 |
| triamine | | | | |
| penta methylene | | | | |
| phosphonic acid | | | | |
| Protease/amylase | 1.5 | 1.4 | 1.3 | 1.3 |
| enzymes | | | | |
| Formic acid | 1.1 | 1.0 | 1.0 | 0 |
| Optical | 0.3 | 0.3 | 0.3 | 0.3 |
| brightener | | | | |
| Ethoxylated | 3.1 | 3.0 | 2.8 | 3.2 |
| polyethyleneimines | | | | |
| Propane diol | 15.6 | 14.7 | 13.9 | 21.9 |
| Monoethanolamine | 11.5 | 10.7 | 10.0 | 8.3 |
| Perfume, dyes | 1.7 | 1.7 | 1.7 | 1.7 |
| Water | 4.4 | 10.0 | 15.0 | 1.7 |

The liquid compositions were packed into film pouches, each pouch containing about 50 ml of liquid. The film was made from polyvinyl alcohol/dicarboxylate copolymer resin (where the comonomer species is itaconic acid). The dissolution and disintegration profiles of each of compositions is good; the pouches dissolve/disintegrate rapidly in water without leaving any residue even after prolonged storage (eight weeks) at 35° C. Compositions 1 to 3 provide a much better cleaning result than the comparative composition because of the presence of a builder/chelant system comprising carboxylate (citric acid) and phosphonate (diethylene triamine penta methylene phosphonic acid) in Compositions 1 to 3.

### COMPARATIVE EXAMPLE

For comparison, an example of a commercially available water-soluble polyvinyl alcohol film is sold under the trade reference M8630 by Mono-Sol of Indiana, US. This particular film has a tensile strength of 281 kg/cm²; modulus of 105 kg/cm²; elongation of 465%; tear resistance of 41 kg/mm; and impact strength of 800 g. It is commercially available in thicknesses of 38, 50 and 76 micrometers. This film is made from polyvinyl alcohol/monocarboxylate copolymer resin. The dissolution and disintegration profiles of Compositions 1 to 3 are poorer than those observed in the previous example with the film made from resin comprising itaconic acid. Furthermore the dissolution/disintegration profiles deteriorate significantly upon storage (eight weeks) at 35° C.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble liquid-containing pouch wherein the water-soluble pouch is made from a film comprising a co-polymer of dicarboxylic acid and wherein the liquid contained within the pouch comprises dissolved ionic components selected from the group consisting of carboxylates, phosphonates, and mixtures thereof.

2. A water-soluble liquid-containing pouch according to claim 1 wherein the film comprises a co-polymer of vinyl alcohol and dicarboxylic acid.

3. A water-soluble liquid-containing pouch according to claim 2 wherein the film comprises a co-polymer comprising from about 0.1 mol % to about 30 mol % of the dicarboxylic acid.

4. A water soluble liquid-containing pouch according to claim 3 wherein the film comprises a co-polymer comprising from about 1 mol % to 6 mol % of the dicarboxylic acid.

5. A water-soluble liquid-containing pouch according to claim 1 wherein the dicarboxylic acid is selected from the group consisting of itaconic acid, maleic acid, malonic acid, succinic acid and mixtures thereof.

6. A water-soluble liquid-containing pouch according to claim 5 wherein the dicarboxylic acid is itaconic acid.

7. A water-soluble liquid-containing pouch according to claim 1 wherein the liquid contained within the pouch has a pH of less than about 9 when measured by dissolving the liquid to a level of 1% in an aqueous medium.

8. A water-soluble liquid-containing pouch according to claim 7 wherein the liquid contained within the pouch has a pH of less than about 8 when measured by dissolving the liquid to a level of 1% in an aqueous medium.

9. A water-soluble liquid-containing pouch according to claim 7 wherein the liquid contained within the pouch has a pH of less than about 7.5 when measured by dissolving the liquid to a level of 1% in an aqueous medium.

10. A water-soluble liquid-containing pouch according to claim 1 wherein the liquid contained within the pouch comprises polycarboxylic acid or polycarboxylate salt.

11. A water-soluble liquid-containing pouch according to claim 1 wherein the liquid contained within the pouch comprises polyphosphonic acid or polyphosphonate salt.
